(19) United States
(12) Patent Application Publication
(10) Pub. No.: US 2026/0227670 A1
(43) Pub. Date: Aug. 6, 2026

(54) OPTICAL BEAM DEFLECTOR INTEGRATED WITH LENS-BASED BEAM DEFLECTOR

(71) Applicant: ELECTRONICS AND TELECOMMUNICATIONS RESEARCH INSTITUTE, Daejeon (KR)

(72) Inventors: Oh Kee KWON, Daejeon (KR); Chul-Wook LEE, Daejeon (KR); Youngsun MOON, Daejeon (KR)

(21) Appl. No.: 19/394,352

(22) Filed: Nov. 19, 2025

(30) Foreign Application Priority Data
Feb. 4, 2025 (KR) 10-2025-0014027

(51) Int. Cl. G02F 1/29

(52) U.S. Cl. CPC G02F 1/294; G02F 2201/066; G02F 2201/12; G02F 2201/302

(57) ABSTRACT

Disclosed is an optical beam deflector. An optical beam deflector includes a substrate including a source region, an amplification region adjacent to the source region, a deflection region adjacent to the amplification region, and an antenna region adjacent to the deflection region, a waveguide layer provided on the substrate and extending from the source region to the antenna region, a lens layer selectively provided on the waveguide layer in the deflection region, and an upper clad layer on the lens layer and the waveguide layer.

### CROSS-REFERENCE TO RELATED APPLICATION

This U.S. non-provisional patent application claims priority under 35 U.S.C. § 119 of Korean Patent Application No. 10-2025-0014027, filed on February 04, 2025, the entire contents of which are hereby incorporated by reference.

### BACKGROUND

The present disclosure herein relates to an optical communication system, and more particularly, to an optical beam deflector configured to transmit an optical signal in a certain direction.

In recent inter-satellite communication, a laser communication method using light instead of an existing RF frequency band has been actively introduced due to the necessity of high-capacity communication, and for miniaturizing/lightening and low-power driving a communication payload. Laser communication operates in an unlicensed band that does not require a permit for use of frequencies, and thus miniaturizing/lightening satellite payload is possible due to reduction in size of an antenna. In addition, a sufficient bandwidth and high directivity enable high-capacity transmission and high energy efficiency. The inter-satellite laser communication requires not only an optical transmitter and receiver for generating and detecting an optical signal, but also a beam steering technology capable of adjusting the direction of a beam radiated from a transmission unit of a satellite in order to form an optical path between the transmission unit and a reception unit of another satellite after location recognition and posture control of the satellite. In general, a beam deflector is being developed in a non-mechanical method instead of a mechanical method.

### SUMMARY

The present disclosure provides an optical beam deflector capable of being equipped with a compact structure, a monolithic structure, and a wide field of view, high performance, low power consumption, and easy operation.

Disclosed is an optical beam deflector. An embodiment of the inventive concept provides an optical beam deflector including: a substrate including a source region, an amplification region adjacent to the source region, a deflection region adjacent to the amplification region, and an antenna region adjacent to the deflection region; a waveguide layer provided on the substrate and extending from the source region to the antenna region; a lens layer selectively provided on the waveguide layer in the deflection region; and an upper clad layer on the lens layer and the waveguide layer.

In an embodiment, the lens layer may have a higher refractive index than that of the waveguide layer.

In an embodiment, the optical beam deflector may further include a lens electrode on the upper clad layer of the lens layer.

In an embodiment, the deflection region may include a coupling region, and a lens region between the coupling region and the antenna region.

In an embodiment, the optical beam deflector may further include a central electrode on the upper clad layer in the lens region and on a center of the lens layer.

In an embodiment, the central electrode may have a butterfly ribbon shape.

In an embodiment, the optical beam deflector may further include focusing electrodes on both edge sides of the lens layer in the lens region.

In an embodiment, the optical beam deflector may further include first edge electrodes between the focusing electrodes and the central electrode, and on one-side edges of the lens layer adjacent to the coupling region; second edge electrodes at edge centers of the lens layer; and third edge electrodes on other-side edges of the lens layer adjacent to the antenna region.

In an embodiment, the optical beam deflector may further include a lower grating in the substrate in the source region.

In an embodiment, the optical beam deflector may further include a phase modulation electrode provided on the upper clad layer in the source region; and a tunable mirror electrode adjacent to the phase modulation electrode and provided on the upper clad layer of the lower grating.

In an embodiment of the inventive concept, an optical beam deflector includes: a substrate including a source region, a splitting region, an amplification region, a coupling region, a lens region, and an antenna region sequentially arranged in a first direction; a waveguide layer provided on the substrate and extending from the source region to the antenna region; a lens layer selectively provided on the waveguide layer in a deflection region; an upper clad layer on the waveguide layer and the lens layer; a source electrode on the upper clad layer in the source region; amplification electrodes on the upper clad layer in the amplification region; and a central electrode on the upper clad layer of the lens layer.

In an embodiment, the optical beam deflector may further include an insulating layer between the central electrode and the upper clad layer.

In an embodiment, the optical beam deflector may further include focusing electrodes at both edge sides of the lens layer in the lens region.

In an embodiment, the optical beam deflector may further include first edge electrodes between the focusing electrodes and the central electrode, and at one-side edges of the lens layer adjacent to the coupling region; second edge electrodes at edge centers of the lens layer; and third electrodes on another side-edges of the lens layer adjacent to the antenna region.

In an embodiment, the optical beam deflector may further include an upper grating between the waveguide layer and the upper clad layer in the antenna region.

In an embodiment of the inventive concept, an optical beam deflector includes: a light source configured to generate a laser beam; a modulator provided adjacent to the light source and configured to modulate the laser beam; a beam splitter connected to the modulator and configured to split the laser beam; an amplifier array connected to the beam splitter and configured to switch the laser beam for each channel; a deflector connected to the amplifier array; and an antenna connected to the deflector, wherein the deflector may include: a slab waveguide between the amplifier array and the antenna; and a lens provided between the slab waveguide and the antenna, and configured to collimate the laser beam to the antenna.

In an embodiment, the optical beam deflector may further include a central electrode on a center of the lens.

In an embodiment, the optical beam deflector may further include focusing electrodes at both edge sides of the lens.

In an embodiment, the optical beam deflector may further include: first edge electrodes on one-side edges of the lens adjacent to the slab waveguide; second edge electrodes adjacent to the first edge electrodes and between the central electrode and the focusing electrodes; and third edge electrodes on another-side edges of the lens adjacent to the antenna.

In an embodiment, the second edge electrodes may have a smaller separation distance than that of the first edge electrodes.

### BRIEF DESCRIPTION OF THE FIGURES

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1 is a plan view showing an example optical beam deflector according to the inventive concept;

FIG. 2 is a plan view taken along line I-I’ of FIG. 1;

FIG. 3 is a simulation result showing an example laser beam in a slab waveguide and a lens of FIG. 1;

FIGS. 4A and 4B are simulation results showing examples of the lens and laser beam of FIG. 1;

FIGS. 5A and 5B are simulation results showing examples of the lens and laser beam of FIG. 1;

FIG. 6 is a plan view showing an example optical beam deflector according to the inventive concept;

FIG. 7 is a plan view taken along line II-II’ of FIG. 6;

FIG. 8 is a plan view showing an example optical beam deflector according to the inventive concept;

FIG. 9 is a plan view showing an example optical beam deflector according to the inventive concept; and

FIG. 10 is a plan view taken along line III-III’ of FIG. 9.

### DETAILED DESCRIPTION

It should be understood that those skilled in the art may fully understand the configuration and effects of the technical idea of the present disclosure, preferred embodiments of the technical idea of the present disclosure will be described with reference to the accompanying drawings. However, the technical idea of the present disclosure is not limited to the embodiments disclosed below and may be implemented in various forms, and various changes may be made. Rather, these embodiments are provided so that this disclosure is thorough and complete and fully conveys the inventive concept to those skilled in the art.

Like reference numerals refer to like elements throughout. Embodiments described herein will be described with reference to block diagrams, perspective views, and/or cross-sectional views, which are ideal illustrations of the technical idea of the present disclosure. In the drawings, the thicknesses of layers and regions are exaggerated for clarity. Accordingly, the regions illustrated in the drawings have schematic properties, and the shapes of the regions illustrated in the drawings are intended to illustrate a specific shape of a region of a device and are not intended to limit the scope of the invention concept. Although different terms are used to describe various components in various embodiments of the present specification, these components should not be limited by these terms. These terms are only used to distinguish one component from another. Embodiments described and illustrated herein also include complementary embodiments thereof.

The terms and words used in the following description and claims are to describe embodiments but not to limit the inventive concept. As used herein, the singular forms “a”, “an” and “the” are intended to include the plural forms as well, unless the context clearly indicates otherwise. It will be further understood that the terms "comprises" and/or "comprising" used herein specify the presence of stated features or components, but do not preclude the presence or addition of one or more other features or components.

Hereinafter, preferred embodiments of the inventive concept will now be described in detail with reference to the accompanying drawings.

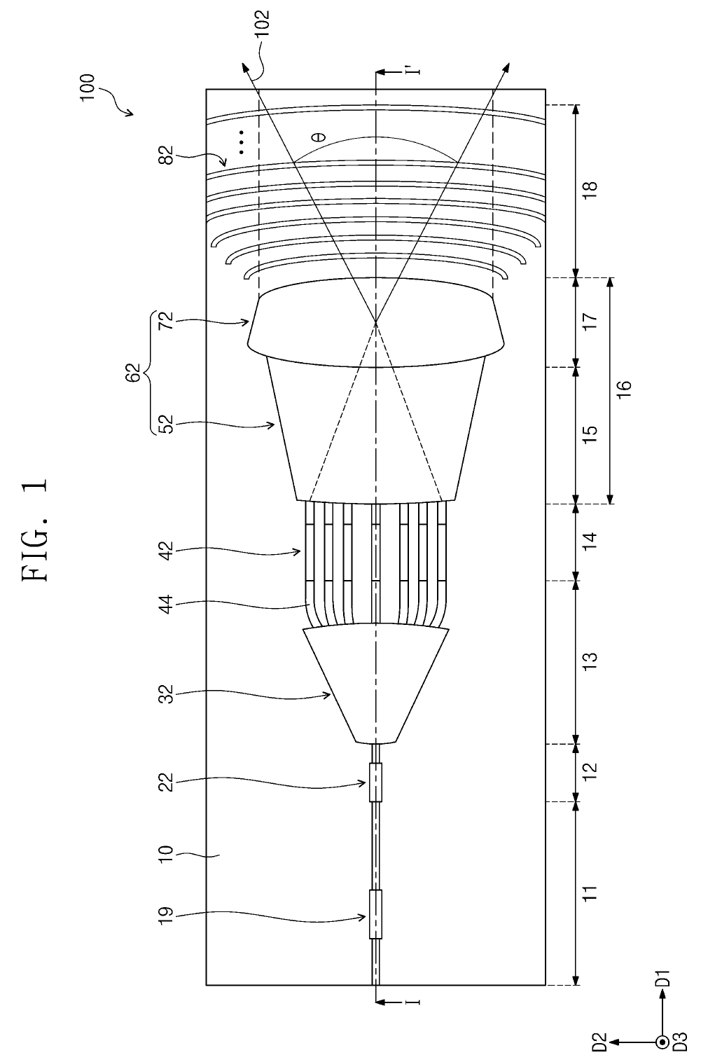

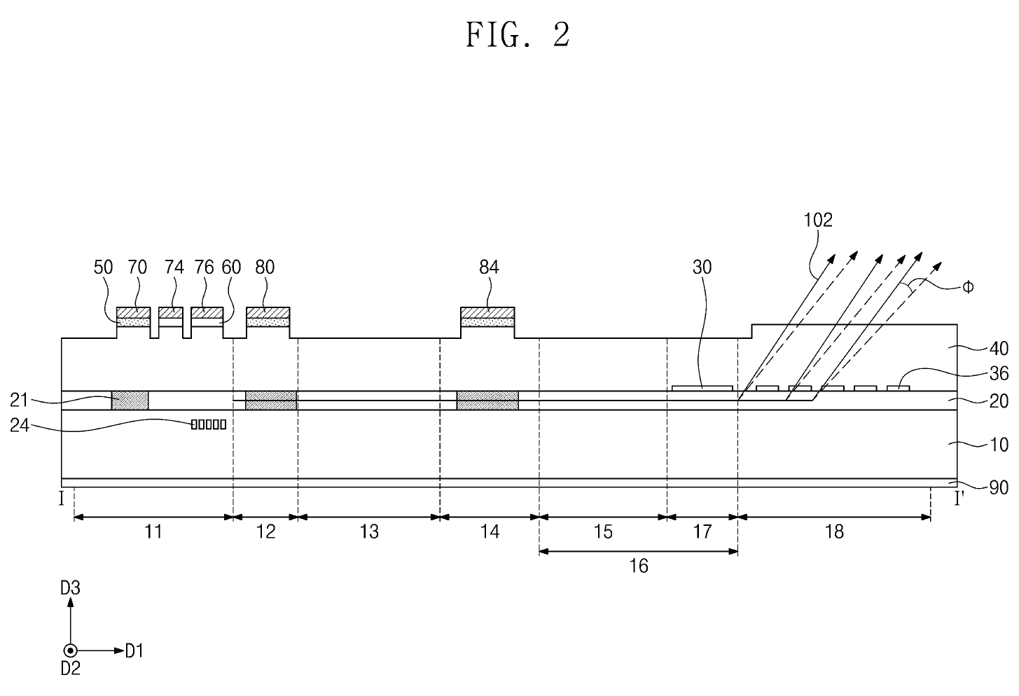

FIG. 1 shows an example optical beam deflector 100 according to the inventive concept. FIG. 2 is a view taken along line I-I’ of FIG. 1.

Referring to FIG. 1, the optical beam deflector 100 of the inventive concept may include a substrate 10, a waveguide layer 20, a lens layer 30, an upper clad layer 40, an ohmic contact layer 50, an insulating layer 60, a source electrode 70, a modulation electrode 80, and an amplification electrode 84.

The substrate 10 may include a lower clad layer of n-type InP. The substrate 10 may include a source region 11, a modulation region 12, a splitting region 13, an amplification region 14, a deflection region 16, and antenna region 18. The source region 11 may be provided with a light source 19. For example, the light source 19 may include a tunable laser diode. The substrate 10 may have a lower grating 24. The lower grating 24 may be provided in the substrate of the source region 11. The modulation region 12 may be provided between the source region 11 and the splitting region 13. The modulation region 12 may be provided with a modulator 22. The modulator 22 may include an intensity modulator. The splitting region 13 may be provided between the modulation region 12 and the amplification region 14. The splitting region 13 may be provided with a beam splitter 32. The amplification region 14 may be provided between the splitting region 13 and the deflection region 16. The amplification region 14 may be provided with an amplifier array 42. The amplifier array 42 may include a semiconductor optical amplifier array. The deflection region 16 may be provided between the amplification region 14 and the antenna region 18. The deflection region 16 may be provided with a deflector 62. According to an example, the deflector 62 may include a slab waveguide 52 and a lens 72. The deflection region 16 may include a coupling region 15 and a lens region 17. The coupling region 15 may be provided between the amplification region 14 and the lens region 17. The coupling region 15 may be a region of the slab waveguide 52. The lens region 17 may be provided between the coupling region 15 and the antenna region 18. The lens region 17 may be provided with the lens 72. The antenna region 18 may be provided adjacent to the lens region 17. The antenna region 18 may be provided with an antenna 82.

The lower electrode 90 may be provided on a lower surface of the substrate 10. The lower electrode 90 may include metals such as gold (Au), silver (Ag), copper (Cu), aluminum (Al), and tungsten (W). Although not shown, the lower electrode 90 may be grounded.

The waveguide layer 20 may be provided on the substrate 10. The waveguide layer 20 may extend from the source region 11 to the antenna region 18 in a first direction D1. The waveguide layer 20 may have a higher refractive index than that of the substrate 10. For example, the waveguide layer 20 may include an intrinsic compound semiconductor material, for example, InGaAsP, InGaAlAs, (Al)GaAs, or InGaAs. The waveguide layer 20 may include an active layer 21 or a gain layer provided in the source region 11, the modulation region 12, and the amplification region 14. The active layer 21 may include a gain material or a quantum well structure. The waveguide layer 20 may be extended or widened in a second direction D2 in the splitting region 13, the coupling region 15, the lens region 17, and the antenna region 18. The waveguide layer 19 may include branch waveguides 44 in the amplification region 14. The branch waveguides 44 may be branched in the splitting region 13 to be coupled in the coupling region 15.

The lens layer 30 may be selectively provided on the waveguide layer 20 in the lens region 17. The lens layer 30 may have a higher refractive index than that of the waveguide layer 20. The lens layer 30 may include a material different from that of the waveguide layer 20. When the waveguide layer 20 includes intrinsic InGaAsP, the lens layer 30 may include InGaAsP, InGaAlAs, (Al)GaAs, or InGaAs with the same or a different composition ratio.

An upper grating 36 may be provided on the waveguide layer 20 in the antenna region 18. The upper grating 36 may have a longer interval than that of the lower grating 24. The upper grating 36 may include the same material as the lens layer 30. The upper grating 36 may include InGaAsP. The length of the upper grating 36 may be proportional to the first direction D1. The length of the upper grating 36 may be defined in the second direction D2.

The upper clad layer 40 may be provided on the upper grating 36, the waveguide layer 20, and the substrate 10. The upper clad layer 40 may have a lower refractive index than that of the waveguide layer 20. The upper clad layer 40 may include p-type InP. The upper clad layer 40 may become thick in the source region 11, the modulation region 12, the amplification region 14, and the antenna region 18.

The ohmic contact layer 50 may be provided on the upper clad layer 40 in the source region 11, the modulation region 12, and the amplification region 14. The ohmic contact layer 50 may include metals of titanium (Ti), platinum (Pt), and gold (Au).

The insulating layer 60 may be provided on a portion of the upper clad layer 40 in the source region 11. The insulating layer 60 may include a dielectric of silicon oxide (SiO₂) or silicon nitride (SiN)

The source electrode 70 may be provided on the ohmic contact layer 50 in the source region 11. The source electrode 70 may use a source current or a source voltage to generate a laser beam 102. The active layer 21 in the source region 11 may acquire a gain of the laser beam 102. The source current may flow between the source electrode 70 and the lower electrode 90. The intensity of the laser beam 102 may be proportional to the source current.

A phase control electrode 74 may be provided on the insulating layer 60 adjacent to the source electrode 70. The phase control electrode 74 may heat a portion of the upper clad layer 40, the waveguide layer 20, and the substrate 10 in the source region 11 to tune the phase of the laser beam 102.

A tuning mirror electrode 76 may be provided on the insulating layer 60 between the phase control electrode 74 and the modulation electrode 80. The tuning mirror electrode 76 may be aligned to the lower grating 24. The tuning mirror electrode 76 and the lower grating 24 may resonate the laser beam 102.

The modulation electrode 80 may be provided on the ohmic contact layer 50 in the modulation region 12. The modulation electrode 80 may use a modulation current or a modulation voltage to modulate the laser beam 102. The laser beam 102 may be modulated to a pulsed laser beam. Then, the laser beam 102 may be provided to the branch waveguides 44 in the splitting region 13.

The amplification electrode 84 may be provided on the ohmic contact layer 50 in the amplification region 14. The laser beam 102 may be amplified. The amplification electrode 84 may be provided individually on the branch waveguides 44. The amplification electrode 84 may drive or switch, for each channel, the laser beam 102 provided to the branch waveguides 44. Namely, a plurality of amplification electrodes 84 may implement channel switching of the laser beam 102. The laser beam 102 may be provided to the slab waveguide 52 in the coupling region 15.

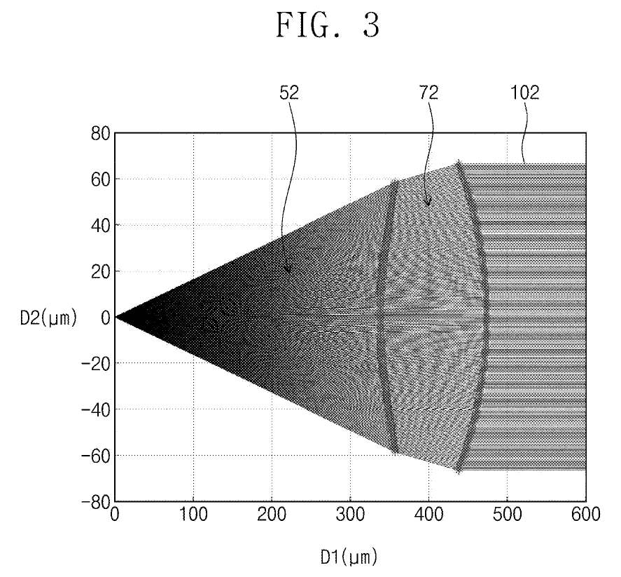

FIG. 3 shows an example of the laser beam 102 in the slab waveguide 52 and the lens 72 of FIG. 1.

Referring to FIG. 3, the slab waveguide 52 radiates the laser beam 102 to the lens 72, and the lens 72 may collimate the laser beam 102.

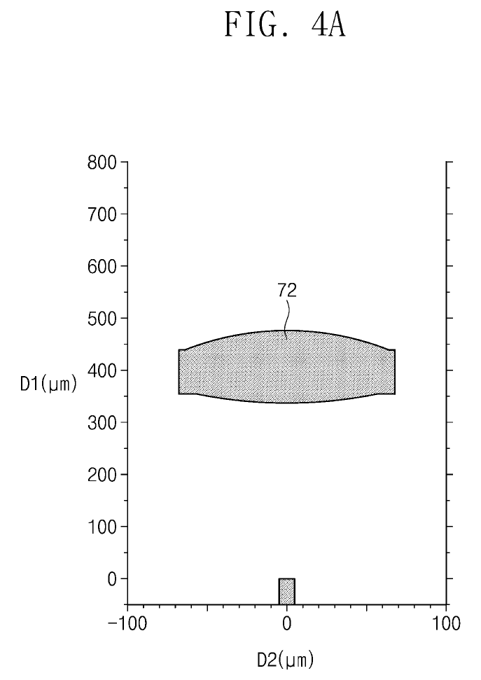

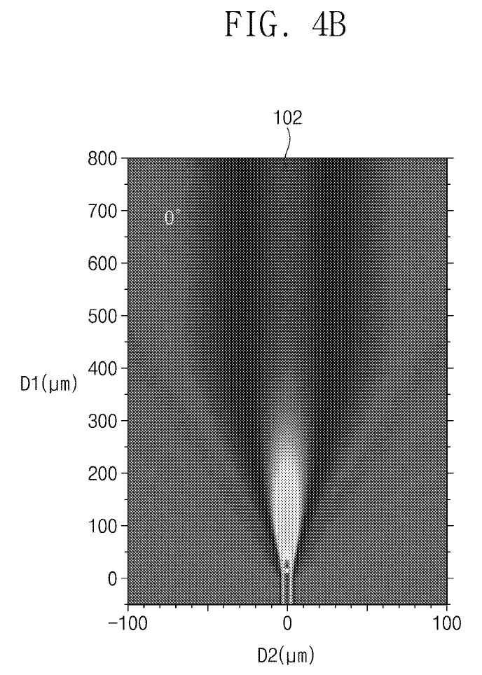

FIGS. 4A and 4B are examples of the lens 72 and the laser beam 102 of FIG. 1.

Referring to FIGS. 4A and 4B, when the lens 72 is symmetrical in the second direction D2, the laser beam 102 may be a collimated beam.

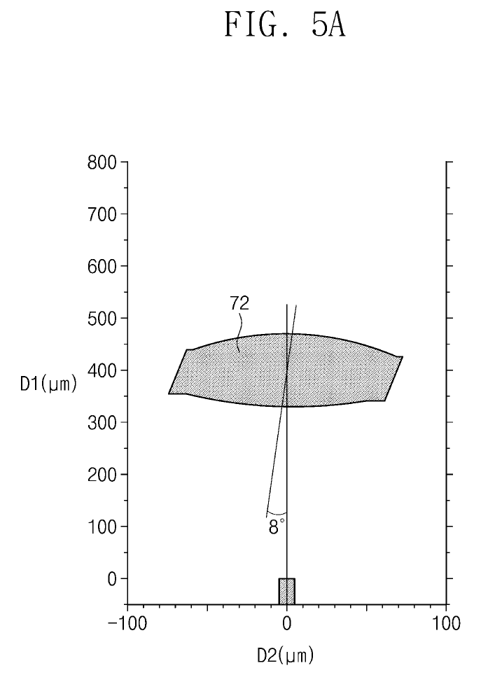

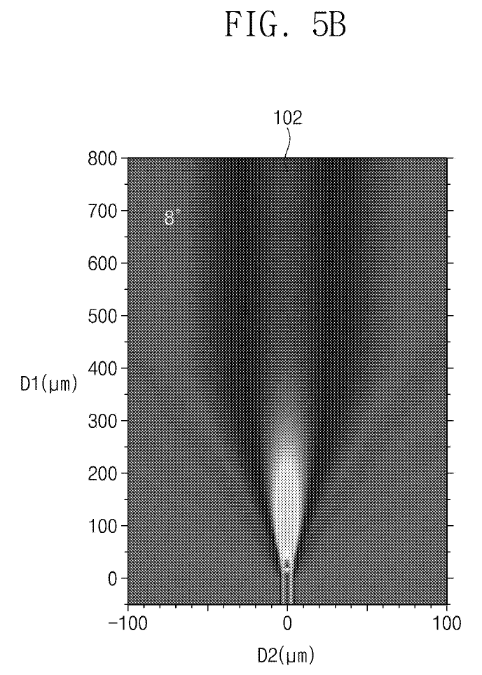

FIGS. 5A and 5B are examples of the lens 72 and the laser beam 102 of FIG. 1.

Referring to FIGS. 5A and 5B, when the lens 72 is inclined in an azimuthal direction of about 8° with respect to the second direction D2, the laser beam 102 may be converted into the collimated beam. The laser beam 102 may be provided to the antenna 82.

Referring again to FIGS. 1 and 2, the antenna 82 may transmit the laser beam 102 in an azimuthal direction (θ) and a polar direction (ϕ). The laser beam 102 may be radiated in the azimuthal direction (θ) along the waveguide layer 20 in the antenna region 18, and be transmitted in the polar direction (ϕ) through the upper grating 36 and the upper clad layer 40.

Accordingly, the optical beam deflector 100 of the inventive concept may have a compact structure, a monolithic integrated structure, and a wide field of view, high performance, low power consumption, and a simple structure by means of the lens layer 30 selectively provided on the waveguide layer 20 in the deflection region 16 of the substrate 10.

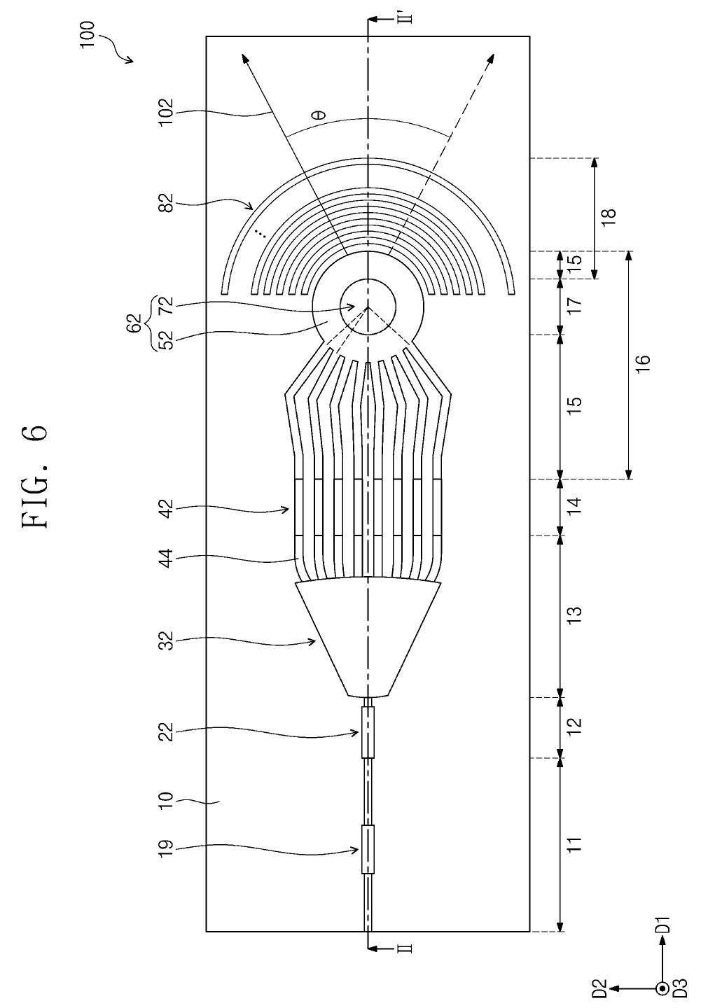

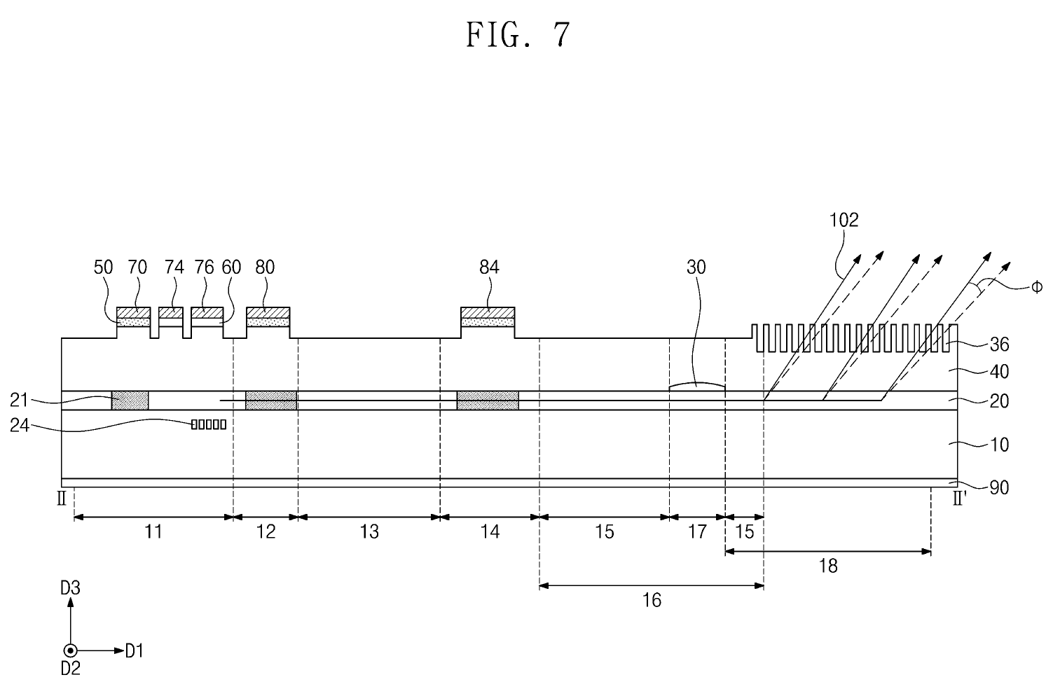

FIG. 6 shows an example optical beam deflector 100 according to the inventive concept. FIG. 7 is a plan view taken along line II-II’ of FIG. 6.

Referring to FIGS. 6 and 7, the deflector 62 of the optical beam deflector 100 of the inventive concept may be circular. Each of the slab waveguide 52 and lens 72 of the deflector 62 may be circular. The slab waveguide 52 may be wider than the lens 72. The lens 72 may be provided on the center of the slab waveguide 52. The lens layer 30 of the lens 72 may include a GRIN lens. For example, the lens layer 30 may have the thickness increasing in the central direction of the lens layer 30. Namely, the lens layer 30 may have an upper convex shape. Although not shown, the lens layer 30 may have a photonic crystal shape, and the embodiment of the inventive concept is not limited thereto.

The upper clad layer 40 in the antenna region 18 may have the upper grating 36 provided at an upper surface of the upper clad layer 40. The upper grating 36 may include a plurality of trenches or grooves.

The substrate 10, the waveguide layer 20, the lens layer 30, the upper clad layer 40, the ohmic contact layer 50, the insulating layer 60, the source electrode 70, the modulation electrode 80, and the amplification electrode 84 may be configured identically to those of FIGS. 1 and 2.

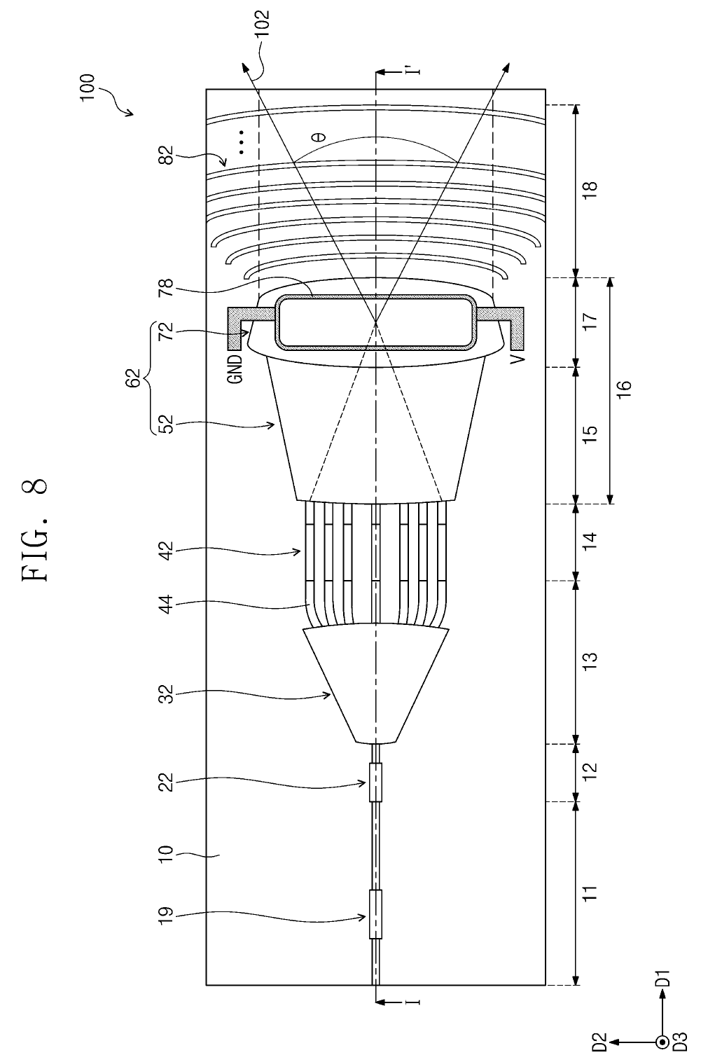

FIG. 8 shows an example optical beam deflector 100 according to the inventive concept.

Referring to FIG. 8, the optical beam deflector 100 may further include a lens electrode 78. For example, the lens electrode 78 may have a circular band shape or a ring shape. The lens electrode 78 may be provided on the edge of the lens 72. Although not shown, the lens electrode 78 may be provided on the upper clad layer 40 of the lens layer 30 (of FIG. 2). The lens electrode 78 may receive the ground voltage GND and a bias voltage V through pads connected to both sides of the lens electrode. The lens electrode 78 may heat the lens 72 or the lens layer 30 to increase the collimation efficiency of the laser beam 102.

The light source 19, the modulator 22, the beam splitter 32, and the amplification array 42, the slab waveguide 52, and the antenna 82 may be configured identically to those of FIG. 1.

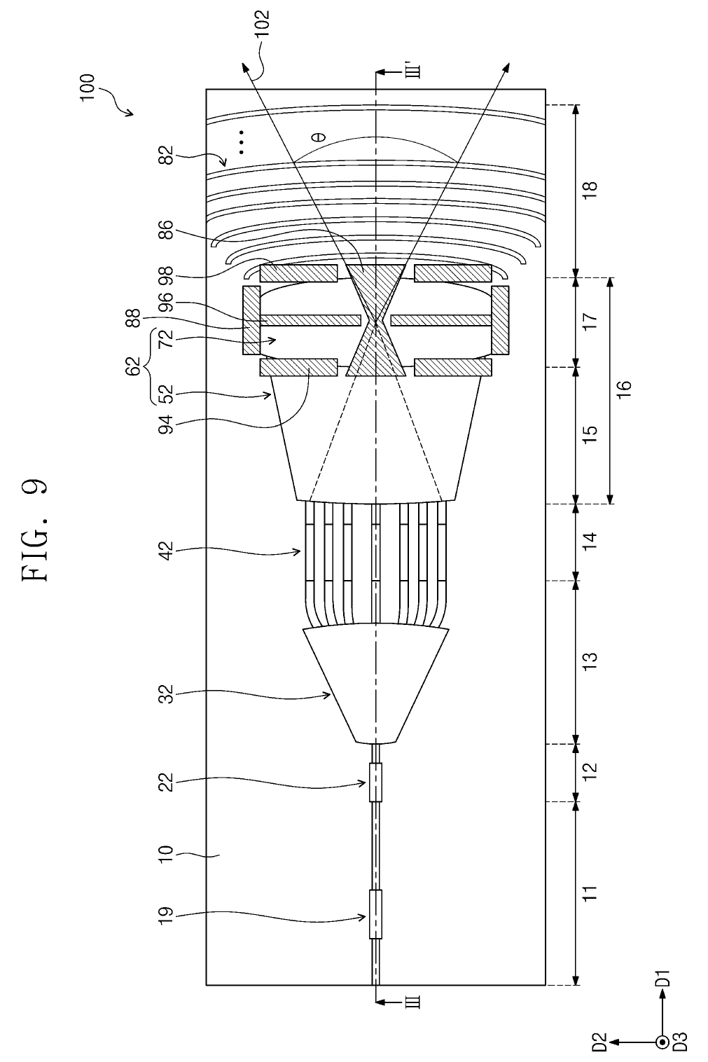

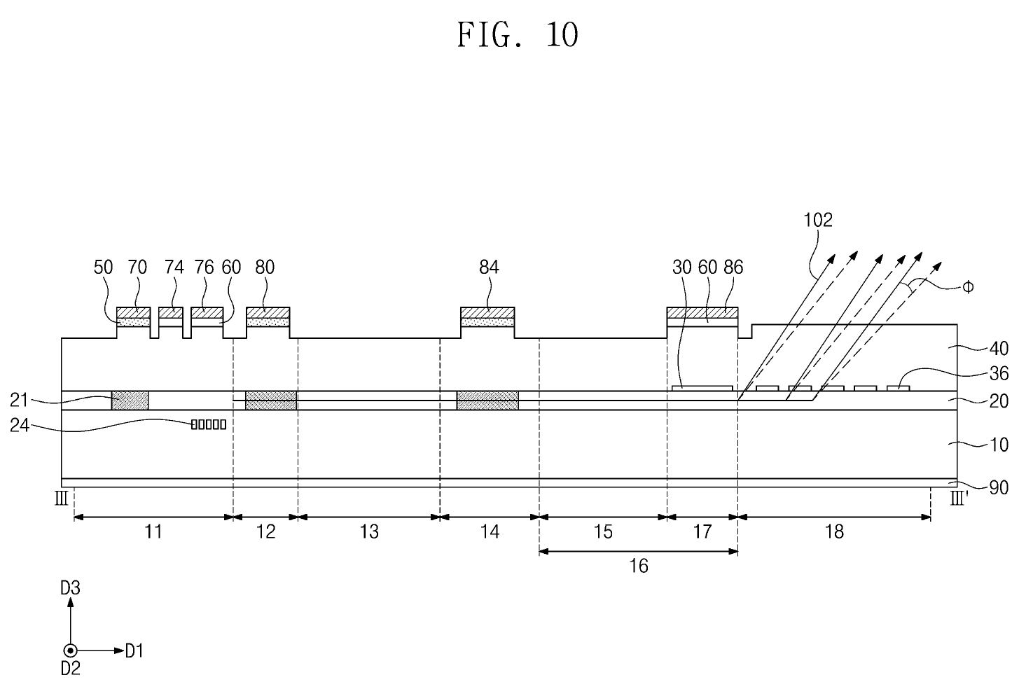

FIG. 9 shows an example optical beam deflector 100 according to the inventive concept. FIG. 10 is a plan view taken along line III-III’ of FIG. 9.

Referring to FIGS. 9 and 10, the optical beam deflector 100 of the inventive concept may further include focusing electrodes 88, a central electrode 86, first edge electrodes 94, second edge electrodes 96, and third edge electrodes 98.

The focusing electrodes 88 may be provided on edges of the lens 72 or the lens layer 30. The focusing electrodes 88 may be spaced apart from each other in the second direction D2. The focusing electrodes 88 may heat the edges of the lens 72 or lens layer 30 in the second direction D2 to increase the collimation efficiency of the laser beam 102.

The central electrode 86 may be provided on the center of the lens 72 or the lens layer 30. The central electrode 86 may heat the center of the lens 72 to increase the collimation efficiency of the laser beam 102. The central electrode 86 may have a butterfly ribbon shape in a plan view. The insulating layer 60 may be provided between the central electrode 86 and the upper clad layer 40. The insulating layer 60 may insulate the central electrode 86 from the upper clad layer 40.

The first edge electrodes 94, the second edge electrodes 96, and the third edge electrodes 98 may be provided between the central electrode 86 and the focusing electrodes 88. The first edge electrodes 94, the second edge electrodes 96, and the third edge electrodes 98 may heat the lens 72 or lens layer 30 in the first direction D1 to increase the collimation efficiency of the laser beam 102.

The first edge electrodes 94 may be provided on one-side corner edges of the lens 72 or lens layer 30 in the first direction D1. The first edge electrodes 94 may be provided on one-side edges of the lens layer 30 adjacent to the coupling region 15. The first edge electrodes 94 may heat the one-side corner edges of the lens 72 or lens layer 30 to increase the collimation efficiency of the laser beam 102.

The second edge electrodes 96 may be provided between the first edge electrodes 94 and the third edge electrodes 98. The second edge electrodes 96 may be provided on the edge centers of the lens layer 30. The second edge electrodes 96 may be provided on the edge centers of the lens 72 or lens layer 30 in the first direction D1. The second edge electrodes 96 may be provided on the corner centers of the lens 72 or lens layer 30 in the first direction D1. The second edge electrodes 96 may be longer than the first edge electrodes 94 and the third edge electrodes 98 in the second direction D2. A separation distance between the second edge electrodes 96 may be smaller than that of the first edge electrodes 94.

The third edge electrodes 98 may be provided on the other-side corner edges of the lens 72 or lens layer 30 in the first direction D1. The third edge electrodes 98 may be provided on the other-side edges of the lens layer 30 adjacent to the antenna region 18. The third edge electrodes 98 may heat the other-side corner edges of the lens 72 or the lens layer 30. A separation distance of the third edge electrodes 98 may be smaller than that of the second edge electrodes 96, and be similar or equal to that of the first edge electrodes 94.

The substrate 10, the waveguide layer 20, the lens layer 30, and the upper clad layer 40 may be configured identically to those of FIGS. 1 and 2.

An optical beam deflector according to an embodiment of the inventive concept may use a lens layer selectively provided on a waveguide layer in a deflection region of a substrate to be equipped with a compact structure, a monolithic structure, and a wide field of view, high performance, low power consumption, and easy operation.

The example embodiments of the present disclosure have been described above with reference to the accompanying drawings, but those skilled in the art will understand that the present disclosure may be implemented in another concrete form without changing the technical spirit or an essential feature thereof. It is therefore to be understood that the above-described subject matter is to be considered illustrative and not restrictive.

What is claimed is:

1. An optical beam deflector comprising:
a substrate comprising a source region, an amplification region adjacent to the source region, a deflection region adjacent to the amplification region, and an antenna region adjacent to the deflection region;
a waveguide layer provided on the substrate and extending from the source region to the antenna region;
a lens layer selectively provided on the waveguide layer in the deflection region; and
an upper clad layer on the lens layer and the waveguide layer.

2. The optical beam deflector of claim 1,
wherein the lens layer has a higher refractive index than that of the waveguide layer.

3. The optical beam deflector of claim 1,
further comprising a lens electrode on the upper clad layer of the lens layer.

4. The optical beam deflector of claim 1,
wherein the deflection region comprises a coupling region, and a lens region between the coupling region and the antenna region.

5. The optical beam deflector of claim 4,
further comprising a central electrode on the upper clad layer in the lens region and on a center of the lens layer.

6. The optical beam deflector of claim 5,
wherein the central electrode has a butterfly ribbon shape.

7. The optical beam deflector of claim 5,
further comprising focusing electrodes on both edge sides of the lens layer in the lens region.

8. The optical beam deflector of claim 7,
further comprising: first edge electrodes provided between the focusing electrodes and the central electrode, and provided on one-side edges of the lens layer adjacent to the coupling region;
second edge electrodes provided at edge centers of the lens layer; and
third edge electrodes provided on other-side edges of the lens layer adjacent to the antenna region.

9. The optical beam deflector of claim 1,
further comprising: a lower grating provided in the substrate in the source region.

10. The optical beam deflector of claim 9,
further comprising: a phase modulation electrode provided on the upper clad layer in the source region; and
a tunable mirror electrode adjacent to the phase modulation electrode and provided on the upper clad layer of the lower grating.

11. An optical beam deflector comprising:
a substrate having a source region, a splitting region, an amplification region, a coupling region, a lens region, and an antenna region sequentially arranged in a first direction;
a waveguide layer provided on the substrate and extending from the source region to the antenna region;
a lens layer selectively provided on the waveguide layer in the antenna region;
an upper clad layer on the waveguide layer and the lens layer;
a source electrode provided on the upper clad layer in the source region;
amplification electrodes provided on the upper clad layer in the amplification region; and
a central electrode provided on the upper clad layer of the lens layer.

12. The optical beam deflector of claim 11,
further comprising an insulating layer provided between the central electrode and the upper clad layer.

13. The optical beam deflector of claim 11,
further comprising focusing electrodes provided at both edge sides of the lens layer in the lens region.

14. The optical beam deflector of claim 13,
further comprising: first edge electrodes between the focusing electrodes and the central electrode, and at one-side edges of the lens layer adjacent to the coupling region;
second edge electrodes at edge centers of the lens layer; and
third electrodes on another side-edges of the lens layer adjacent to the antenna region.

15. The optical beam deflector of claim 11,
further comprising an upper grating between the waveguide layer and the upper clad layer in the antenna region.

16. An optical beam deflector comprising:
a light source configured to generate a laser beam;
a modulator provided adjacent to the light source and configured to modulate the laser beam;
a beam splitter connected to the modulator and configured to split the laser beam;
an amplifier array connected to the beam splitter and configured to switch the laser beam for each channel;
a deflector connected to the amplifier array; and
an antenna connected to the deflector,
wherein the deflector comprises:
a slab waveguide between the amplifier array and the antenna; and
a lens provided between the slab waveguide and the antenna, and configured to collimate the laser beam to the antenna.

17. The optical beam deflector of claim 16,
further comprising a central electrode on a center of the lens.

18. The optical beam deflector of claim 17,
further comprising focusing electrodes at both edge sides of the lens.

19. The optical beam deflector of claim 18,
further comprising: first edge electrodes on one-side edges of the lens adjacent to the slab waveguide;
second edge electrodes adjacent to the first edge electrodes and between the central electrode and the focusing electrodes; and
third edge electrodes on another-side edges of the lens adjacent to the antenna.

20. The optical beam deflector of claim 19,
wherein the second edge electrodes have a smaller separation distance than that of the first edge electrodes.
